(19) United States
(12) Patent Application Publication
(10) Pub. No.: US 2020/0172644 A1
(43) Pub. Date: Jun. 4, 2020

(54) CORE-SHELL NANOPARTICLES AND THEIR USE IN ADHESIVE FORMULATIONS

(71) Applicant: The Provost, Fellows, Foundation Scholars and the Other Members of Board of the College of the Holy, Dublin (IE)

(72) Inventors: Renata TEKORIUTE, Co Dublin Dun Laoghaire (IE); Gemma-Louise DAVIES, Coventry, Warwickshire (GB); Joseph Edward GOVAN, Dublin (IE); Yuri GUNKO, Co Dublin Donabate (IE)

(21) Appl. No.: 16/628,979

(22) PCT Filed: Jul. 6, 2018
(86) PCT No.: PCT/EP2018/068357

§ 371 Date: Jan. 6, 2020

(30) Foreign Application Priority Data
Jul. 7, 2017 (EP) 17180377.8

(51) Int. Cl. C08F 20/06; C09J 133/10; H01F 1/00; H01F 1/34

(52) U.S. Cl. CPC C08F 20/06; C09J 133/10; C08K 5/56; H01F 1/344; H01F 1/0054

(57) ABSTRACT

The present invention relates to magnetic core-shell a nanoparticles, as well as to their use in the initiation of redox-triggered polymerisation processes. The invention also relates to a formulation comprising the magnetic core-shell nanoparticles, and particularly an adhesive formulation, as well as to associated methods of controlling the adhesion of at least two adherends utilising the adhesive formulation. Further embodiments of the invention relate to methods of controlling redox-triggered polymerisation processes, and particularly redox radical-triggered adhesive polymerisation.

The present invention relates to core-shell nanoparticles, as well as to their use in the initiation of redox-triggered polymerisation processes. The invention also relates to a formulation comprising the core-shell nanoparticles, and particularly an adhesive formulation, as well as to associated methods of controlling the adhesion of at least two adherends utilising the adhesive formulation. Further embodiments of the invention relate to methods of controlling redox-triggered polymerisation processes, and particularly redox radical-triggered adhesive polymerisation.

On-demand triggering of industrially-relevant processes is of increasing importance, particularly in relation to those processes which employ highly reactive chemical formulations. Such formulations, which often suffer from poor stability, can be unsuitable for processing via fast-moving production lines due to issues with storage, control and handling.

This is particularly the case in the adhesives industry. Anaerobic adhesives and sealants form the basis of a multi-million dollar industry, with these products being used in diverse applications such as the chemical bonding and locking of threaded parts, retention of cylindrical machine components and sealing of porous metal casings, amongst other important uses.

Anaerobic adhesives are single component adhesives that are generally comprised of mixtures of mono- and multi-functional methacrylate ester monomers with cure chemistries based on a redox radical initiator system. At ambient temperatures and in the presence of oxygen, such anaerobic adhesives remain stable and un-reacted for extended periods of time. Normally, very fast polymerisation is initiated when oxygen is excluded upon the addition of suitably active substrates (i.e. redox agents) to the monomer mixture.

However, on fast-moving production lines, highly reactive adhesive chemistries with short cure times are not considered appropriate or structurally robust enough for many applications. As the reactivity of the redox initiation used to promote rapid anaerobic adhesive polymerisation increases, a concomitant decrease in storage stability of the adhesive composition is observed, with associated handling problems. Thus, highly reactive adhesive processing necessitates the development of novel means of stabilisation, control and activation to facilitate use of the adhesive formulation.

On-demand triggering of adhesive polymerisation, in which the polymerisation is initiated at a desired time point, is clearly desirable. On-demand triggering of such reactions has previously been performed by a variety of approaches, including thermal, chemical, photochemical, redox and mechanical means. However, each of these mechanisms suffer from disadvantages. Photo-activated adhesives, for example, require high energy ultraviolet light and the addition of expensive photo-initiators. Photo-initiation is also inherently restricted to light-transparent substrates, thus limiting the utility of this technique. Pressure and heat activation are energy-demanding activation techniques, which also frequently result in the damage of substrates (e.g. plastics) during the adhesion process. In more recent times, adhesive curing via electrochemical triggering has been reported. However, this process demonstrates slow response times (˜20 minutes for 10% conversion to occur) (A. J. D. Magenau, N. C. Strandwitz, A. Gennaro and K. Matyjaszewski, Science, 2011, 332, 81-84).

Accordingly, a process for controlling and triggering polymerisation processes, applicable to fast-curing adhesive reactions, and that addresses one or more of the disadvantages set out above would be of significant benefit. A process that could trigger polymerisation, particularly of an adhesive formulation, and which demonstrates one or more of: fast response times, simplicity, cost-effectiveness and scalability would be particularly beneficial.

### SUMMARY

The inventors have advantageously determined that nanoparticles comprising a core comprising a magnetic material and a shell comprising an oxidising agent can be used to control redox initiated polymerization reactions. The nanoparticles can be included in formulations comprising a redox radical initiator system. The oxidising agent serves to inhibit the reaction by preventing initiation via the redox radical initiator system. The simple application of a magnetic field to the formulation, attracts the nanoparticles from the bulk of the formulation, and allows rapid redox-initiated reaction to occur. The nanoparticles, and formulations comprising same, thus have the ability to provide stable, on-demand triggered formulations.

In embodiments of the invention, adhesive formulations comprising the nanoparticles are described.

The invention also relates to a container for an adhesive formulation, which comprises a dispenser comprising a magnetic material.

According to the present invention there is provided a pre-polymerisation formulation comprising:

(i) a nanoparticle comprising: a core comprising a magnetic material; and a shell comprising apolymerisation-inhibiting oxidising agent;

(ii) at least one monomer capable of undergoing redox-initiated polymerisation; and

(iii) a redox radical initiator system.

As noted above, the nanoparticles of the invention comprise a shell comprising a polymerisation-inhibiting oxidising agent. The functional oxide shell prevents reduction of a component of a redox reaction pair included in the formulation, and hence inhibits polymerisation. The redox potential of the oxidising agent must therefore be higher than that of the redox reaction pair component whose reduction is to be inhibited.

The term “pre-polymerisation formulation” is used herein to define a polymerisable formulation, composition, combination, dispersion and/or mixture of at least the three components or ingredients (i), (ii) and (iii) listed above, without or prior to any chemical reaction thereinbetween, and having a stable co-existence, typically but not limited to being in a suspension form, such as a colloidal suspension.

In one embodiment of the present invention, the pre-polymerisation formulation is a stable colloidal suspension.

The term “polymerisation-inhibiting oxidising agent” is used herein to define an oxidising agent whose presence throughout the pre-polymerisation formulation inhibits or prevents redox-initiated polymerisation, and whose withdrawal away from a sufficient amount of the monomer(s) and initiator system allow polymerisation to begin.

The hardness or form of the shell of the nanoparticle is not limited in the present invention. That is, the shell comprising the polymerisation-inhibiting oxidising agent may be in the form of a ‘hard’ and defined shell, or may have a ‘softer’ and less-well defined nature.

In an embodiment, the oxidising agent is selected from the group consisting of MnO₂, CeO₂, ReO₂, OsO₄t, ammonium cerium (IV) nitrate, an inorganic peroxide, an organic peroxide and an organic oxidant. Examples of suitable inorganic peroxides include, metal peroxides such as MgO₂, ZnO₂ and Cu₂O₂, metal perborates such as Zn(BO₃)₂, persulfates such as ZnS₂O₈ and chromates such as ZnCrO₄, Examples of suitable organic peroxides include acetyl acetone peroxide and acetyl benzoyl peroxide. Examples of suitable organic oxidants include tert-butyl hypochlorite and Sarett Reagent. However, the oxidising agent is not particularly limited once it can prevent reduction of the redox reaction pair component of the redox reaction initiator system.

In an embodiment, the oxidising agent is MnO₂. Manganese dioxide (MnO₂) is a strong oxidant (E°=+1.23 vs NHE) and can be used to prevent reduction of the oxidant material in a variety of redox reaction pairs. For instance, MnO₂ can be used to inhibit copper-mediated polymerisation, by inhibiting the reduction of Cu(II) to Cu(I) (+0.15 V vs NHE (Normal Hydrogen Electrode)).

Advantageously, the inclusion of a magnetic core in the nanoparticles facilitates easy removal of the nanoparticles from the polymerisable formulation via the application of a magnetic field. Thus, the magnetic material is not particularly limited, once it exhibits sufficient attraction to an external magnetic field to allow the coated nanoparticles to be attracted thereto. In this manner, the magnetic nanoparticles, which before attraction to the magnetic field are dispersed throughout the formulation, are removed from the bulk of the formulation and attracted towards the magnetic field. This may be towards the side or bottom of a container or reservoir comprising the formulation, for example, depending on where the magnetic field is applied. This magnetic attraction thereby reduces the concentration of the nanoparticles in the bulk of the formulation, allowing reduction of a component of the redox reaction pair to take place, with consequential initiation of the polymerisation reaction.

In an embodiment, the magnetic material is selected from the group consisting of magnetite, a ferrite; iron, nickel, cobalt, and a magnetic alloy including an alloy of iron, nickel or cobalt.

In an embodiment, the magnetic material is a ferrite. In an embodiment of the invention, the magnetic material is CoFe₂O₄. Cobalt ferrite (CoFe₂O₄) nanoparticles possess high magnetic moment and saturation magnetisation values. Due to their strong and immediate attraction to external magnetic fields, CoFe₂O₄ nanoparticles are particularly suitable for use in the core/shell nanoparticles of the invention.

In an embodiment, the formulation is an adhesive formulation, i.e. a pre-former for an adhesive, and able to be for use as an adhesive once polymerisation is allowed to start.

In an embodiment of the invention, the at least one monomer capable of undergoing redox-initiated polymerisation is an ester monomer. Examples of suitable ester monomers include triethyleneglycol dimethacrylate (TRIEGMA), trimethylolpropane trimethacrylate, ethoxylated bisphenol, dicyclopentadienyl, hydroxyethyl, hydroxypropyl, cyclohexyl, tetrahydrofurfuryl, dimethylaminoethyl, glycidyl methacrylates, and cyanoethyl acrylate. In an embodiment, the ester monomer is a methacrylate ester monomer. Mono- and multi-functional methacrylate ester monomers are commonly used components in anaerobic adhesive formulations, and their cure chemistry is based on a redox radical initiator system. Thus, these monomers are particularly suitable for use in the formulations of the invention, in which the nanoparticles can control initiation of their cure chemistry by preventing reduction of a redox component in the redox radical initiator system.

In an embodiment, the methacrylate ester monomer is triethyleneglycol dimethacrylate (TRIEGMA) or trimethylolpropane trimethacrylate.

In an embodiment, the redox radical initiator system comprises a transition metal and a peroxide.

The transition metal can be any transition metal with adjacent oxidation states, such as Cu(I/II), Fe(I/II), Mn(III/IV) etc.

Any suitable peroxide can be used. Suitable examples include t-butyl peroxybenzoate, cumene hydroperoxide, t-butylhydroperoxide, p-menthane hydroperoxide , diisopropylbenzene hydroperoxide, pinene hydroperoxide, methyl ethyl ketone hydroperoxide, di-t-butylperoxide, dicumylperoxide and t-butylperoxymaleic acid.

The above noted transition metals and peroxides can be used in any combination.

In an embodiment, the transition metal is copper.

In an embodiment, the redox radical initiator system comprises comprises copper (II) tetrafluoroborate hydrate.

In an embodiment, the redox radical initiator system comprises tert-butyl peroxybenzoate.

In an embodiment, the redox radical initiator system comprises comprises copper (II) tetrafluoroborate hydrate and tert-butyl peroxybenzoate.

According to an aspect of the present invention there is provided a pre-polymerisation or polymerisable formulation as described above for subsequent use as an adhesive. As noted above, the nanoparticles can prevent reduction of a component of a redox reaction pair typically included as an initiator in adhesives. Facile removal of the nanoparticles from the bulk of the formulation via contact with or proximity to a magnetic field, can allow the redox reaction to take place in the bulk of the formulation, triggering polymerisation and adhesion. The formulation can therefore be considered to be an on-demand activatable adhesive.

According to an aspect of the invention there is provided use of a nanoparticle comprising a core comprising a magnetic material and a shell comprising a polymerisation-inhibiting oxidising agent as an additive in an adhesive.

According to an aspect of the invention there is provided a nanoparticle comprising a core comprising a magnetic material, wherein the magnetic material is CoFe₂O₄, and a shell comprising a polymerisation-inhibiting oxidising agent.

The inventive nanoparticles can be used as an additive in an adhesive as described previously.

According to an aspect of the invention there is provided a method of initiating a redox-triggered polymerisation process comprising at least the steps of:
providing a pre-polymerisation formulation comprising at least one monomer capable of undergoing redox-initiated polymerisation; a redox radical initiator system, and nanoparticles comprising a core comprising a magnetic material and a shell comprising apolymerisation-inhibiting oxidising agent dispersed within the formulation; and
applying a magnetic field to the formulation such that at least a portion of the nanoparticles are attracted thereto.

Optionally, the method of initiating a redox-triggered polymerisation process consists of or consists essentially of the steps defined above.

By “at least a portion of the nanoparticles are attracted thereto” it is meant that a sufficient portion of the nanoparticles are attracted to the magnetic field, and are thereby removed from the bulk of the formulation, such that the concentration of nanoparticles remaining in the bulk of the formulation is insufficient to prevent reduction of a component of the redox radical initiator system.

In an embodiment, the step of applying a magnetic field to the formulation comprises bringing the formulation into contact or proximity with a permanent magnet. This can be done, for instance, by holding or siting a magnet in proximity to the formulation itself, or by holding or siting a magnet in proximity to a container or reservoir in which the formulation is contained. In embodiments, the formulation could pass through an external magnetic field, for instance on an assembly line.

The term “proximity” can be taken to mean that the magnet is brought sufficiently close to the formulation such that the magnetic nanoparticles are attracted to the magnet. An example of such proximity could be, for instance, a range of 1 mm to 100 cm, but is not particularly limited once the magnetic nanoparticles are attracted to the magnet.

According to an aspect of the invention there is provided a method of controlling the adhesion between at least two adherends, comprising at least the steps of:
applying a polymerisation-inhibiting formulation as described above between the at least two adherends, and
applying a magnetic field to the formulation such that at least a portion of the nanoparticles in the formulation are attracted thereto.

Optionally, the step of applying a magnetic field to the formulation comprises bringing the formulation into contact or proximity with a permanent magnet.

Optionally, the method of controlling the adhesion between at least two adherends, consists of or consists essentially of the steps defined above.

A schematic of this aspect of the invention is shown in FIG. 1, which shows, in b) nanoparticles comprising a CoFe₂O₄ magnetic core and an MnO₂ oxidising outer shell preventing reduction of a transition metal (Cu^{II}) in an adhesive formulation. FIG. 1c) shows that after removal of the magnetic particles using a magnetic field, reduction of Cu^{II} to Cu^{I} in the formulation between the steel plates occurs, catalysing polymerisation and resulting in successful adhesion of the plates.

Advantageously, this embodiment of the invention allows in-situ activation of the formulation and may be particularly suitable, for instance, for adhering components in an industrial process.

According to an aspect of the invention there is provided a container for an adhesive comprising:

a reservoir for containing an adhesive pre-polymerisation formulation; and

a dispenser,

wherein the container comprises a magnetic material positioned such that the formulation is brought into proximity or contact with the magnetic material when the formulation is dispensed through the dispenser.

As the formulation passes through the dispenser and/or thereafter, polymerisation is initiated in the rearranged composition, leading to the formation of the adhesive beyond the container.

In an embodiment, the dispenser comprises the magnetic material.

In an embodiment, the reservoir comprises an adhesive pre-polymerisation formulation comprising nanoparticles comprising a core comprising a magnetic material. The formulation may be the formulation described in detail above.

Advantageously, the inventors have demonstrated that a formulation comprising the nanoparticles as discussed above, is stable over time. Removal of the nanoparticles from the bulk of formulation, ceases inhibition of the redox radical initiation reaction and triggers activation of the formulation, which can then polymerise and adhere two adherends to which it is applied. Thus, the formulation can be stored in the container until adhesion is required, at which point rapid adhesion can be initiated by dispensing the formulation through the magnetic dispenser.

The present invention is not limited to removal of the nanoparticles from the formulation, but removal from a sufficient portion of the formulation, such that the concentration of nanoparticles portion is insufficient to prevent reduction of a component of the redox radical initiator system.

According to an aspect of the invention there is provided a method of applying an adhesive to a surface, the method comprising:

providing a container as described above, and

dispensing the formulation through the dispenser such that at least a portion of the nanoparticles are attracted to the magnetic material.

In this embodiment, the adhesive formulation can be activated as it is dispensed from the container.

### FIGURES

FIG. 1: a) Anaerobic adhesive formulation. Schematic representation of b) inhibition of adhesion by CoFe₂O₄/MnO₂ core-shell nanoparticles and c) subsequent triggering of polymerisation/adhesion following magnetic removal of CoFe₂O₄/MnO₂ core-shell nanoparticles.

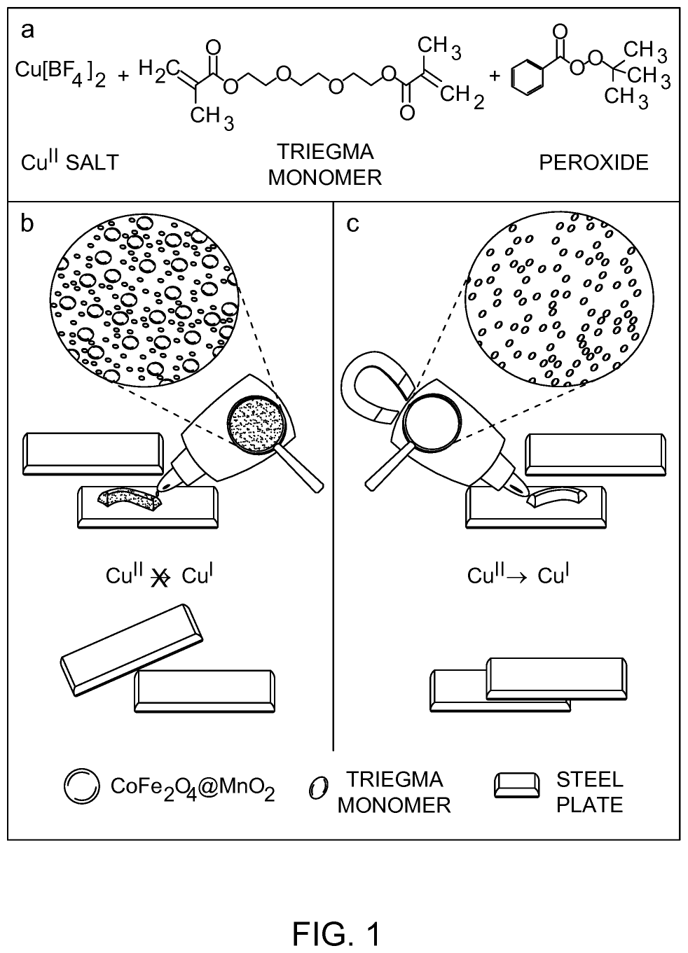

FIG. 2: TEM images of a) MnO₂ nanoparticles, b) CoFe₂O₄ nanoparticles, c) and d) CoFe₂O₄/MnO₂ core-shell nanoparticles. Scale bar is 100 nm.

FIG. 3: X-ray powder diffraction patterns of MnO₂, CoFe₂O₄ and CoFe₂O₄/MnO₂ core-shell nanoparticles. * represents the δ-MnO₂ phase and # represents CoFe₂O₄ cubic spinel phase present in the core/shell particles, as labelled.

FIG. 4: Raman spectra of a) CoFe₂O₄ nanoparticles and b) CoFe₂O₄/MnO₂ core/shell nanoparticles.

FIG. 5: FTIR spectra of a) CoFe₂O₄ nanoparticles and b) CoFe₂O₄/MnO₂ nanoparticles.

FIG. 6: Magnetisation curves of CoFe₂O₄ and CoFe₂O₄/MnO₂ nanoparticles.

FIG. 7: Schematic of adhesion procedure and testing of anaerobic adhesive formulations.

FIG. 8: Plot of normalised transmittance of the C═C bond of TRIEGMA (1637 cm⁻¹) for unmodified adhesive formulation with optimised CoFe₂O₄/MnO₂ nanoparticles present and after they had been removed.

FIG. 9: Change in gelation time with increasing concentration of CoFe₂O₄/MnO₂ nanocomposites in adhesive formulation at 82° C.

FIG. 10: Screen shots of a demonstration video showing anaerobic adhesive formulations with CoFe₂O₄/MnO₂ nanocomposite additives used for adhering glass to metal. Image A shows the formulation deposited on glass in the presence of a permanent magnet and the nanocomposites being moved in the presence of the magnetic field, and image B shows the glass bound to a stainless steel plate after magnetic separation of the nanocomposites from the formulation.

### EXAMPLES

The following examples are intended to be illustrative only.

Materials

All chemicals were used as obtained from Sigma-Aldrich. Steel plates for adhesion testing (Q-Panel RS-14) were purchased from q-lab and were cleaned thoroughly with acetone prior to use.

Methodology

A JEOL JEM-2100, 200 kV LaB₆ transmission electron microscope operated at 120 kV with a beam current of ˜65 mA was used to image nanoparticle samples. Aqueous suspensions were drop-cast onto a formvar coated copper grid for imaging.

Size analysis was carried out using ImageJ software. X-ray powder diffraction was performed using a Siemens-500 X-ray diffractometer. Powder samples were adhered on silica glass using silica gel and overnight spectra were run for all samples. Diffractograms were compared to the JCPDS database. FTIR spectroscopy was performed using a Perkin Elmer Spectrum One NTS FTIR spectrometer. C═C bond monitoring experiments were conducted using a Perkin Elmer Spectrum 100 FTIR spectrometer using a diamond ATR attachment. Micro Raman spectra were recorded using a Renishaw 1000 micro-Raman system fitted with a Leica microscope and Grams Research TM analysis software. The excitation wavelength was 633 nm from a Renishaw RL633 He-Ne laser. Vibrating sample magnetometry (VSM) was carried out at room temperature with field applied up to 1 Tesla using a home-built machine. VSM was calibrated using a nickel sample of known mass; magnetisation values are representative of the total mass of the sample.

### EXAMPLE 1

### Preparation of MnO₂ Nanoparticles

MnO₂ nanoparticles were prepared by reaction of KMnO₄ (0.5 g, 3.14 mmol) in Millipore water (250 mL) with oleic acid (5 ml, 0.016 mol) using ultrasonication (40 mins), followed by stirring (2.5 h) at room temperature (H. M. Chen and J. H. He, Chemistry Letters, 2007, 36, 174-175). The resulting dark brown precipitate was washed with ethanol using centrifugation and dried under vacuum at 80° C.

### EXAMPLE 2

### Preparation of CoFe₂O₄ Nanoparticles

CoFe₂O₄ nanoparticles were prepared by the basic co-precipitation of cobalt (II) nitrate hexahydrate (0.58 g, 2 mmol) and iron (II) chloride tetrahydrate (0.80 g, 4 mmol) in deoxygenated Millipore water (100 mL) using ammonium hydroxide solution (28 v/v %, to a pH of 11) under heating at 80-90° C. for 1 h (G.-L. Davies, S. A. Corr, C. J. Meledandri, L. Briode, D. F. Brougham and Y. K. Gun'ko, ChemPhysChem, 2011, 12, 772-776). Particles were washed with Millipore water, isolated using centrifugation and dried under vacuum at room temperature.

### EXAMPLE 3

### Preparation of CoFe₂O₄/MnO₂ Core-Shell Nanoparticles

CoFe₂O₄/MnO₂ core/shell nanoparticles were produced through controlled deposition of MnO₂ on the surface of the CoFe₂O₄ nanoparticles prepared in Example 2 above. CoFe₂O₄ nanoparticles (0.15 g, 0.64 mmol) were dispersed into degassed Millipore water (153 mL) in a round bottomed flask. KMnO₄ (0.31 g, 1.95 mmol) was then added and stirred to mix. A thermometer was inserted into the flask and the suspension was heated with vigorous stirring to 80° C. Oleic acid (3.06 mL, 9.7 mmol) was added, and the solution was stirred for 1 h at 80° C. and then allowed to stir at room temperature overnight. The resulting nanomaterials were isolated using magnetic separation, washed four times with ethanol and the isolated material was dried under vacuum.

### EXAMPLE 4

### Preparation of Adhesive Formulation

Adhesive formulations were prepared by mixing a solution of triethyleneglycol dimethacrylate (TRIEGMA, 10 mL, 0.037 mol), copper (II) tetrafluoroborate hydrate (Cu(II), 0.088 g, 0.37 mmol) and tert-butyl peroxybenzoate (98%, peroxide, 1 mL, 5.26 mmol) with nanoparticles (MnO₂, CoFe₂O₄, CoFe₂O₄/MnO₂ or control reagents) in various ratios, as described in Tables 1 and 2.

TABLE 1
Ratios of MnCO₂ and CoFe₂O₄/MnCO₂ samples tested for adhesion
inhibition properties and their adhesion capabilities (✓ for
successful adhesion, x for unsuccessful adhesion).

| | | Deactivation | | Adhesion |
|---|---|---|---|---|
| | Mass ratio | of adhesion in | | post |
| | of par- | presence of | Magnetic | magnetic |
| Sample | ticles:Cu^{II} | particles^{[a]} | removal^{[b]} | removal^{[c]} |
| MnO₂ | 1:1 | x | x | —^{[d]} |
| | 2:1 | ✓ | x | —^{[d]} |
| | 3:1 | ✓ | x | —^{[d]} |
| CoFe₂O₄/MnO₂ | 4.5:1 | ✓ | ✓ | x |
| | 4:1 | ✓ | ✓ | x |
| | 3.5:1 | ✓ | ✓ | ✓ |
| | 3:1 | x | ✓ | ✓ |
| | 1.3:1 | x | ✓ | ✓ |
| | 1:1.3 | x | ✓ | ✓ |

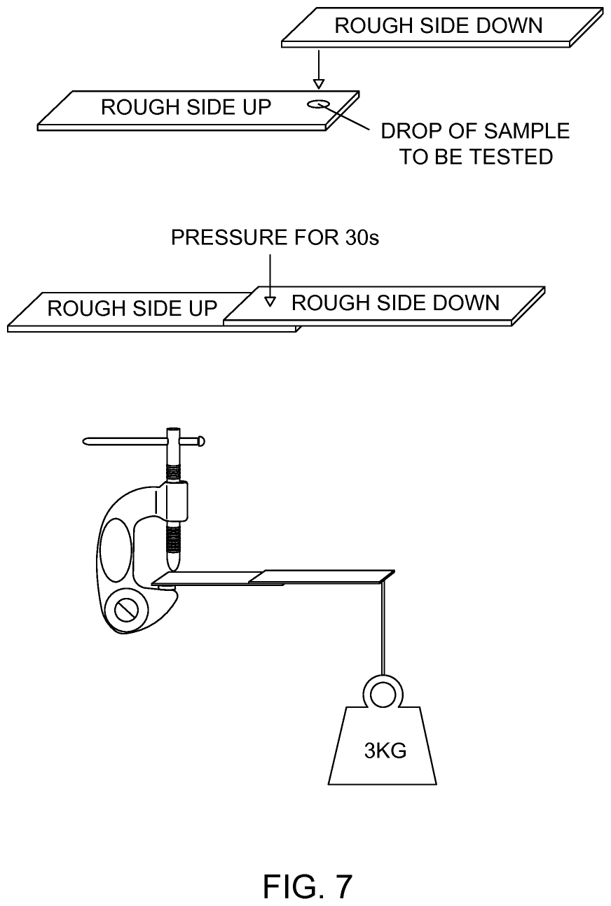

^{[a]}Deactivation of adhesion defined as prevention of reduction of Cu^{II} to Cu^{I}, polymerisation and hence no adhesion of metal plates using adhesion tests (FIG. 7).
^{[b]}Ability to attract the nanocomposite sample system from the bulk of the formulation using an external magnetic field.
^{[c]}After removal of nanoparticles from the bulk of the formulation by the magnetic field, assessment of supernatant adhesion as per [a].
^{[d]}Not applicable due to lack of magnetic characteristics.

TABLE 2
Summary of the conditions required to achieve polymerisation
(and hence metal substrate adhesion) in the absence and presence
of nanoparticles (optimised ratios) and control systems (✓ for
successful adhesion, x for unsuccessful adhesion).

| | Deactivation of | Magnetic | Adhesion post |
|---|---|---|---|
| Sample | adhesion^{[a]} | removal^{[b]} | magnetic removal^{[c]} |
| MnO₂^{[e]} | ✓ | x | —^{[d]} |
| Oleic acid^{[f]} | x | x | —^{[d]} |
| KMnO₄^{[g]} | x | x | —^{[d]} |
| CoFe₂O₄^{[h]} | x | ✓ | ✓ |
| CoFe₂O₄/MnO₂^{[i]} | ✓ | ✓ | ✓ |

^{[a]}Deactivation of adhesion defined as prevention of reduction of Cu^{II} to Cu^{I}, polymerisation and hence no adhesion of metal plates using adhesion tests.
^{[b]}Ability to attract the sample system from the bulk of the formulation using an external magnetic field.
^{[c]}After removal of nanoparticles from the bulk of the formulation by the magnetic field, assessment of adhesion as per [a].
^{[d]}Not applicable due to lack of magnetic characteristics.
^{[e]}2:1 mass ratio of particles:Cu^{II}.
^{[f]}5:1 mass ratio of oleic acid:Cu^{II}.
^{[g]}1:1 mass ratio of KMnO₄:Cu^{II}.
^{[h]}5:1 mass ratio of particles:Cu^{II}.
^{[i]}3.5:1 mass ratio of particles:Cu^{II}.

### EXAMPLE 5

### Characterisation of Nanoparticles

5.1 Transmission Electron Microscopy (TEM)

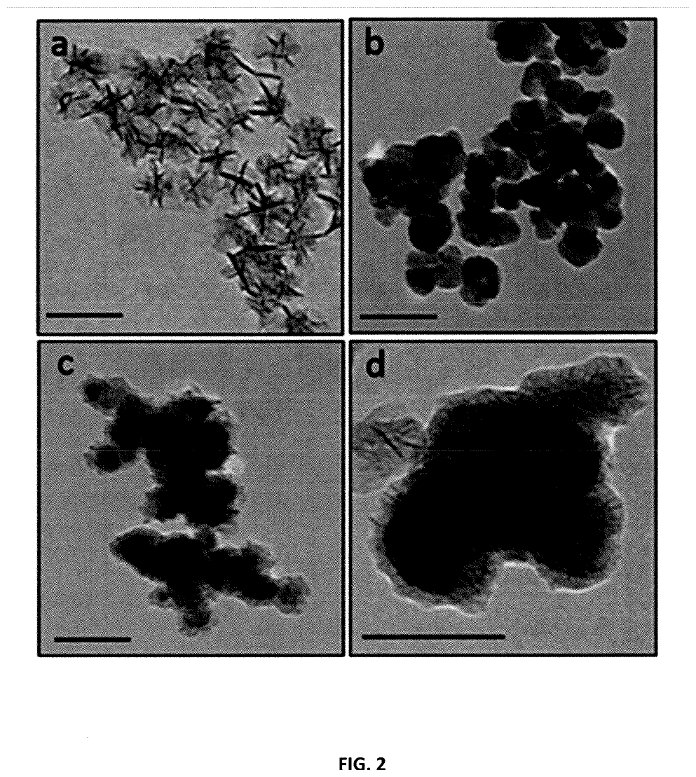

CoFe₂O₄/MnO₂ core-shell nanoparticles were imaged using Transmission Electron Microscopy (TEM) and TEM images of uncoated MnO₂ nanoparticles (46.7±8.1 nm diameter), uncoated CoFe₂O₄ nanoparticles (41.0±15.1 nm diameter) and CoFe₂O₄/MnO₂ core-shell nanoparticles (52.8±19.6 nm diameter) are shown in FIGS. 2a (uncoated MnO₂ nanoparticles), 2b (uncoated CoFe₂O₄ nanoparticles) and 2c and 2d (CoFe₂O₄/MnO₂ core-shell nanoparticles). The images showed CoFe₂O₄/MnO₂ core-shell nanoparticles with an MnO₂ shell of 7±3 nm thickness.

5.2 X-Ray Diffraction (XRD)

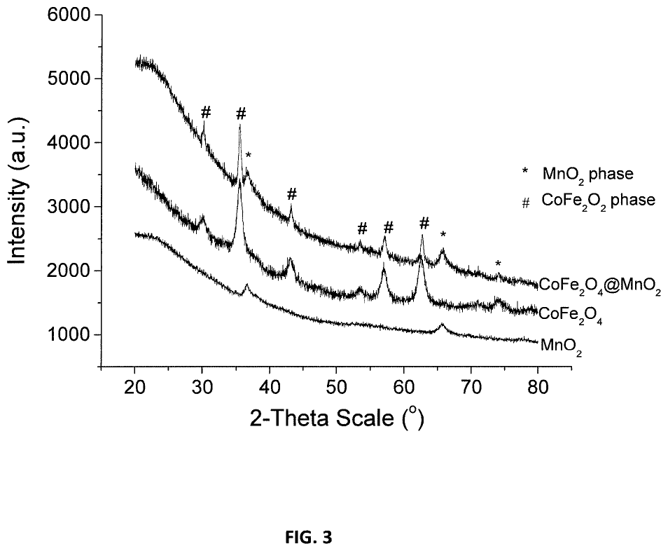

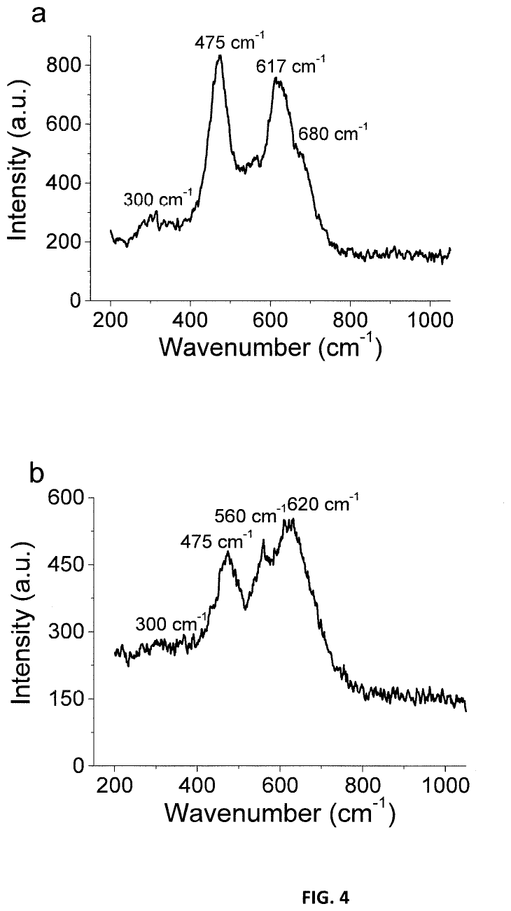

X-ray diffraction (XRD) analysis confirmed the presence of both cubic inverse spinel CoFe2O4 and δ-MnO₂ phases (FIG. 3). The presence of both of these oxide phases in the nanostructures was also confirmed by Raman Spectroscopy (FIG. 4), in which Raman modes at 680 cm⁻¹, 617 cm⁻¹, 475 cm⁻¹ and 300 cm⁻¹ are characteristic of the cubic inverse spinel structure of CoFe₂O₃ (Davies, G.-L.; Corr, S. A.; Meledandri, C. J.; Briode, L.; Brougham, D. F.; Gun'ko, Y. K., NMR relaxation of water in nanostructures: Analysis of ferromagnetic cobalt-ferrite polyelectrolyte nanocomposites. ChemPhysChem 2011, 12, 772-776) and peaks at 560 cm⁻¹ and 620 cm⁻¹ (increased intensity compared to CoFe₂O₄ alone) are characteristic of δ-MnO₂ (Julien, C. M.; Massot, M.; Poinsignon, C., Lattice vibrations of manganese oxides: Part i. Periodic structures. Spectrochimica Acta Part A: Molecular and Biomolecular Spectroscopy 2004, 60, 689-700).

5.3 Fourier-Transform Infrared Spectroscopy (FTIR)

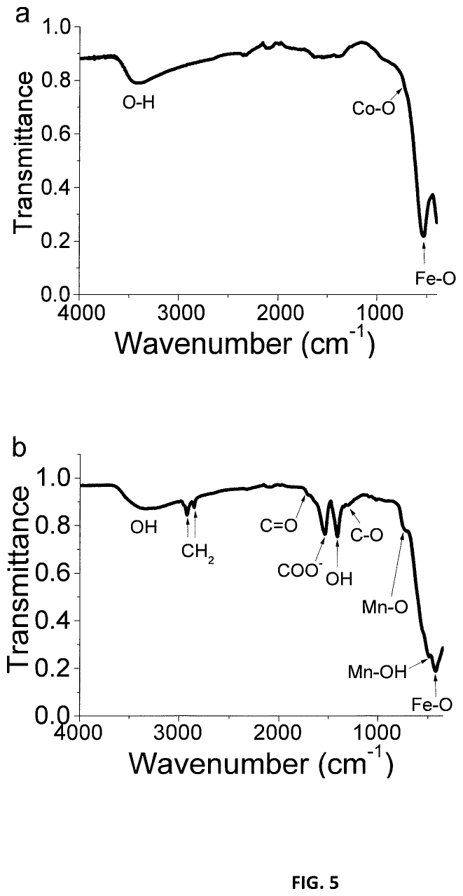

FTIR spectra are shown in FIG. 5. FIG. 5a) is the FTIR spectrum of CoFe₂O₄ nanoparticles showing Fe—O stretching vibrations (530 cm⁻¹), a small shoulder representing Co—O stretching vibrations (720 cm⁻¹) and hydroxyl group stretching vibrations (3400 cm⁻¹), as labelled and b) CoFe₂O₄/MnO₂ nanoparticles showing Mn—O stretching and Mn—O—H bending vibrations (725 and 490 cm⁻¹), characteristic Fe—O vibrations, hydroxyl groups stretches (3400 cm⁻¹) as well as distinctive peaks for oleic acid, including asymmetric and symmetric CH₂ stretches (2925 and 2850 cm⁻¹), C═O and C—O stretches (1712 and 1340 cm⁻¹), O—H (1410 cm⁻¹) and asymmetric COO⁻ stretches (1535 cm⁻¹), as labelled (Julien, C. M.; Massot, M.; Poinsignon, C., Lattice vibrations of manganese oxides: Part i. Periodic structures. Spectrochimica Acta Part A: Molecular and Biomolecular Spectroscopy 2004, 60, 689-700; and Limaye, M. V.; Singh, S. B.; Date, S. K.; Kothari, D.; Reddy, V. R.; Gupta, A.; Sathe, V.; Choudhary, R. J.; Kulkarni, S. K., High coercivity of oleic acid capped CoFe₂O₄ nanoparticles at room temperature. The Journal of Physical Chemistry B 2009, 113, 9070-9076).

5.4 Magnetisation Studies

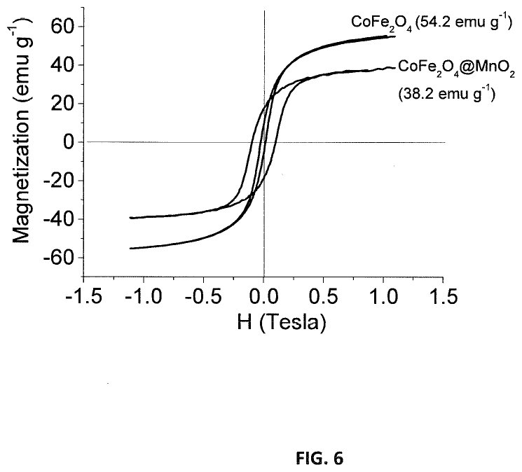

Magnetisation curves of CoFe₂O₄ and CoFe₂O₄/MnO₂ nanoparticles are shown in FIG. 6. Samples demonstrate hysteresis loops indicative of ferromagnetism. Saturation magnetisation values (as labelled, based on total mass of sample) decrease upon MnO₂ coating, as expected due to the presence of the non-magnetic MnO₂ layer.

The magnetisation measurements additionally demonstrated that the core/shell nanostructures retained strong magnetisation behaviour despite the presence of the MnO₂ shell (FIG. 6), indicating their ability to be manipulated with ease using an external magnet.

### EXAMPLE 6

### Removal of Nanoparticles

6.1 From Adhesive Formulation

Activation of the adhesive formulation was performed by placing a permanent magnet (˜0.05 T) alongside a container containing the adhesive formulation and holding the magnet in close proximity to the container for approximately 1 minute. After this time, the CoFe₂O₄/MnO₂ nanoparticles were removed to the surface of the container in proximity to the magnet, and the remaining adhesive formulation was free of nanoparticles. Aliquots of the nanoparticle-free formulation were taken and tested for adhesive capability as in Example 7 below.

Control experiments demonstrated that MnO₂ nanoparticles could not be removed from the adhesive formulation by the application of an external magnetic field.

6.2 In Situ

The adhesive formulation comprising CoFe₂O₄/MnO₂ core-shell nanoparticles was applied to surfaces to be adhered. A magnet was placed at the joint to be adhered, and held in place for 1 minute. Adhesion was subsequently tested as in Example 7 below.

### EXAMPLE 7

### Adhesion Studies

Adhesive capability was assessed by applying the adhesive (in the absence or presence of nanoparticle samples) to stainless steel test panels (see Schematic shown in FIG. 7). The panels were held together using a clip for a set period of time (30 sec) and then tested for adhesion by connecting one of the panels to a 3 kg weight and holding for 20 seconds. The adhesives were also tested after magnetic removal of the nanoparticles (1-3 min beside a permanent magnet) and subsequent testing of the supernatant, or by placing the magnet next to an adhesive joint between steel and glass plates. A strong adhesive joint was deemed to have been formed if the joint remained intact for a minimum of 20 s.

7.1 MnO₂

The amount of MnO₂ nanoparticles added to the adhesive formulation was initially varied to determine the optimal amount required to prevent polymerisation and hence plate adhesion. It was found that at a mass ratio of 2:1 or higher of MnO₂:Cu(II) no adhesion was observed, indicating that the MnO₂ nanoparticles inhibited polymerisation. However, as noted in Example 6.1 above, MnO₂ nanoparticles could not be removed by the application of an external magnetic field.

7.2 CoFe₂O₄/MnO₂ core-shell nanoparticles

The procedure outlined above was repeated using the CoFe₂O₄/MnO₂ core-shell nanoparticles prepared in Example 3. The CoFe₂O₄/MnO₂ core-shell nanoparticles successfully inhibited polymerisation of adhesive formulations and substrate fixing at mass ratios of 3.5:1 of CoFe₂O₄/MnO₂:Cu(II) and above.

Ratios below this amount were not sufficient to deactivate the polymerisation process and resulted in adhesion of the metal substrates in the presence of the nanocomposites.

7.3 Adhesive Following Removal of Nanoparticles

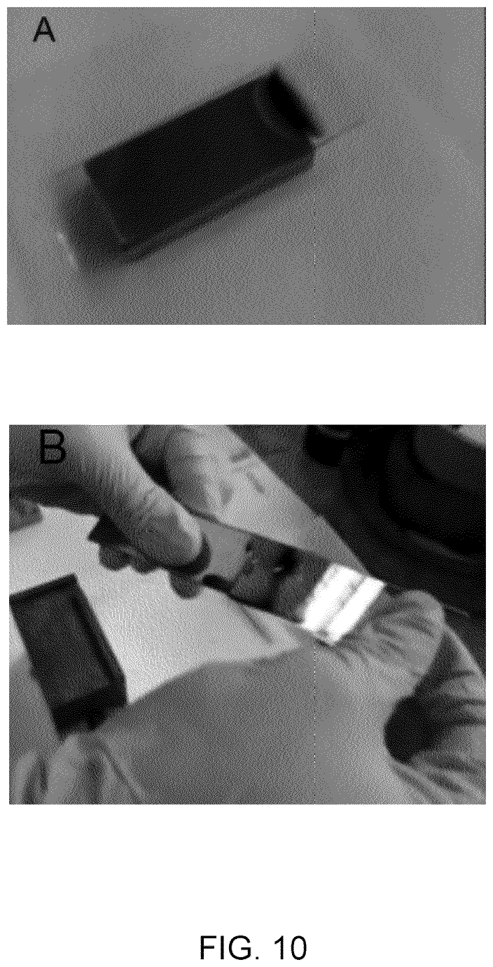

The CoFe₂O₄/MnO₂ core-shell nanoparticles were removed from the adhesive formulation as detailed in Example 6 above. The remaining adhesive successfully fixed the metal substrates within 30 s post-removal. FIG. 10 shows screen shots of a demonstration video showing anaerobic adhesive formulations with CoFe₂O₄/MnO₂ nanocomposite additives used for adhering glass to metal. Image A shows the formulation deposited on glass in the presence of a permanent magnet and the nanocomposites being moved in the presence of the magnetic field and B the glass bound to a stainless steel plate after magnetic separation of the nanocomposites from the formulation.

7.4 Control Experiments

In order to ensure that none of the individual nanocomposite components caused the deactivation/activation behaviour observed, a number of control experiments were performed. Oleic acid, KMnO₄ and non-coated CoFe₂O₄ nanoparticles were tested in the adhesive formulation and showed no deactivation of adhesive capability in their presence and no capability of magnetically triggered adhesion.

7.5 Adhesion after Three Weeks

The CoFe₂O₄/MnO₂ core-shell nanoparticle-containing adhesive formulation prepared in Example 4 was allowed to stand at ambient temperature conditions for three weeks. After this time, the anaerobic adhesion texts outlined in Example 7 were repeated. Similar results to those of the original experiments were obtained, i.e. the colloidal mixture comprising the CoFe₂O₄/MnO₂ core-shell nanoparticles still successfully deactivated polymerisation and substrate adhesion and, upon magnetic removal of the nanoparticles, provided an adhesive which was capable of triggering the polymerisation reaction and adhesion of the metal substrates. This clearly demonstrates the long-term stability and activity of the adhesive formulation.

### EXAMPLE 8

### Characterisation of Adhesion

Real-time FTIR spectroscopy can be used to analyse the progression of polymerisation of adhesive, through monitoring of the C═C stretch (band maximum at 1637 cm⁻¹), whose increase in transmittance intensity is characteristic of vinyl polymerisation on metal and glass surfaces (Yang, D. B., Direct kinetic measurements of vinyl polymerization on metal and silicon surfaces using real-time FT-IR spectroscopy. Applied Spectroscopy 1993, 47, 1425-1429) and is therefore indicative of the polymerisation of TRIEGMA in the adhesive formulation in contact with a steel substrate with respect to time.

Real-time FTIR spectroscopy was carried out through deposition of a droplet of the adhesive formulation either with or without nanoparticles on the diamond of the ATR system followed by attachment of a steel plate substrate. FTIR spectra were recorded every 30 seconds for 30 minutes in total. The change in the transmittance intensity of the 1637 cm⁻¹ band (corresponding to C═C bond in TRIEGMA) was monitored and behaviour analysed.

The degree of vinyl monomer consumption is directly related to the increase of the IR transmittance band at 1637 cm⁻¹; the % conversion of the system can be calculated from equation 1:

$$\% conversion = ( \frac{{A}_{0} - {A}_{t}}{{A}_{0}} ) * 100 \qquad ( 1 )$$

Where Ao represents the absorbance at 1637 cm⁻¹ at time 0 and Aₜ represents the absorbance at 1637 cm⁻¹ at time t. Absorbance values were calculated from the transmittance data collected using equation 2:

Aₜ=−lnTₜ (2)

Where Tₜ is transmittance intensity at time t.

The adhesive formulation, the adhesive formulation comprising CoFe₂O₄/MnO₂ nanoparticles and the adhesive formulation after the CoFe₂O₄/MnO₂ nanoparticles had been magnetically removed were analysed by FTIR as outlined above.

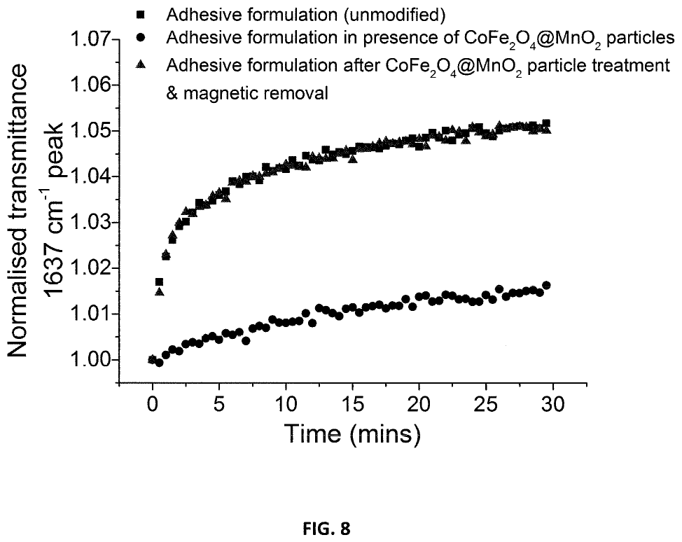

The transmittance intensity of the 1637 cm⁻¹ band of the unmodified adhesive formulation showed an initial rapid increase as C═C bonds were converted to C—C bonds during polymerisation, which then slowed over time (FIG. 8). This behaviour is typical for a rapid polymerisation process which reduces in rate as available monomer species are consumed during the fast curing process. The formulation containing CoFe₂O₄/MnO₂ nanoparticles showed similar behaviour, but with considerably less overall change in transmittance, indicating that only very limited polymerisation occurred under bonding conditions and the lack of significant changes in transmittance profile are indicative of remaining C═C bonds in the unpolymerised TRIEGMA monomer. Most importantly, after magnetic removal of the core/shell nanoparticles from the adhesive formulation, the trend in transmittance intensity was almost identical to that of the unmodified formulation. The restoration of the polymerisation behaviour to that of the initial unmodified adhesive formulation clearly demonstrates that the polymerisation behaviour is not negatively affected by the inclusion of the particles and remains equivalent to native, unmodified samples after nanoparticle removal.

Analysis of the conversion of the monomer with respect to curing time supports this, with the unmodified formulation showing 17.9% conversion after 30 minutes cure time. In the presence of the core/shell nanoparticles on the other hand, conversion only reaches 8.0%. This degree of conversion is not enough for a strong adhesive bond to be formed, as demonstrated in previous adhesion tests. After magnetic removal of the particles, the formulation reaches a 17.2% conversion after 30 minutes cure time, similar to the unmodified formulation, demonstrating that the formulation can still be applied as an efficient adhesive, forming strong bonds.

### EXAMPLE 9

### Stability Studies

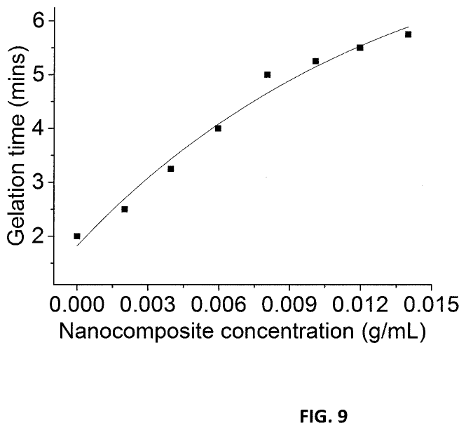

Adhesives were tested for long-term stability using an industry-standard accelerated ageing testing protocol (Henkel Loctite STM-08, with alterations). The adhesive formulation (˜1 mL) was placed within a 12 mm diameter test-tube to which was then placed an applicator stick. Each test tube was then placed into an aluminium heating block set to 82° C. At set times, the agglutination of each formulation (minimum 2 replications) was tested by pulling the applicator stick out of the test tube. If the adhesive formulation offered resistance to removal of the applicator stick the sample was determined to have polymerised (gelled). As expected, the stability of the active formulation increased with increasing concentration of CeFe₂O₄/MnO₂ nanoparticles (FIG. 9).

The inventors have thus demonstrated that magnetic core shell nanoparticles can be successfully used for magnetically-triggered reaction initiation, and particularly for controlling and initiating adhesion in an anaerobic adhesive.

1. A pre-polymerisation formulation comprising:
(i) a nanoparticle comprising a core comprising a magnetic material, and a shell comprising a polymerisation-inhibiting oxidising agent;
(ii) at least one monomer capable of undergoing redox-initiated polymerisation; and
(iii) a redox radical initiator system.

2. A formulation as claimed in claim 1, wherein the at least one monomer is a methacrylate ester monomer.

3. A formulation as claimed in claim 2, wherein the at least one methacrylate ester monomer is triethyleneglycol dimethacrylate.

4. A formulation as claimed in claim 1 wherein the redox radical initiator system comprises copper (II) tetrafluoroborate hydrate and tert-butyl peroxybenzoate.

5. A formulation as claimed in claim 1, wherein the magnetic material is selected from the group consisting of magnetite, a ferrite, iron, nickel, cobalt, and magnetic alloys.

6. A formulation as claimed in claim 5, wherein the magnetic material is a ferrite.

7. A formulation as claimed in claim 6, wherein the ferrite is CoFe₂O₄.

8. A formulation as claimed in claim 1, wherein the oxidising agent is selected from the group consisting of MnO₂, CeO₂, ReO₂, OsO₄, ammonium cerium (IV) nitrate, an inorganic peroxide, an organic peroxide and an organic oxidant.

9. A formulation as claimed in claim wherein the oxidising agent is MnO₂.

10. A formulation as claimed in claim 1 for use as an adhesive.

11. A nanoparticle comprising:
a core comprising a magnetic material, wherein the magnetic material is CoFe₂O₄; and
a shell comprising a polymerisation-inhibiting oxidising agent.

12. A nanoparticle as claimed in claim 11 wherein the oxidising agent is as defined in claim 8.

13. Use of a nanoparticle comprising a core comprising a magnetic material and a shell comprising a polymerisation-inhibiting oxidising agent as an additive in a pre-polymerisation adhesive formulation.

14. (canceled)

15. A method of initiating a redox-triggered polymerisation process comprising at least the steps of:
(a) providing a pre-polymerisation formulation comprising (i) at least one monomer capable of undergoing redox-initiated polymerisation; (ii) a redox radical initiator system, and (iii) nanoparticles comprising a core comprising a magnetic material and a shell comprising a polymerisation-inhibiting oxidising agent dispersed within the formulation; and
(b) applying a magnetic field to the formulation such that at least a portion of the nanoparticles are attracted thereto.

16. A method as claimed in claim 15, wherein the step of applying a magnetic field to the formulation comprises bringing the formulation into contact or proximity with a permanent magnet.

17. A method of controlling the adhesion between at least two adherends, comprising:
applying a pre-polymerisation formulation as claimed in any of claims 1 to 9 claim 1 between the at least two adherends, and
applying a magnetic field to the formulation such that at least a portion of the nanoparticles in the formulation are attracted thereto.

18. A method as claimed in claim 17 comprising bringing a magnet into proximity or contact with the adherends such that at least a portion of the nanoparticles in the formulation are attracted thereto.

19. A container for an adhesive comprising:
a reservoir for containing an adhesive pre-polymerisation formulation as defined in claim 1; and
a dispenser;
wherein the container comprises a magnetic material positioned such that the formulation is brought into proximity or contact with the magnetic material when the formulation is dispensed through the dispenser.

20. A container for containing an adhesive as claimed in claim 19, wherein the reservoir comprises an adhesive pre-polymerisation formulation comprising nanoparticles comprising a core comprising a magnetic material.

21. A method of applying an adhesive to a surface, the method comprising:
providing a container as claimed in claim 20, and
dispensing the adhesive pre-polymerisation formulation through the dispenser such that at least a portion of the nanoparticles in the formulation are attracted to the magnetic material.
